(19) United States
(12) Patent Application Publication
(10) Pub. No.: US 2026/0081319 A1
(43) Pub. Date: Mar. 19, 2026

(54) SYSTEMS AND METHODS FOR DISTRIBUTED BATTERY CIRCUIT ISOLATION VIA PYROTECHNIC DISCONNECT

(71) Applicant: Textron Inc., Providence, RI (US)

(72) Inventors: Charles Daniel Dauchess, North Augusta, SC (US); Russell William King, Evans, GA (US); Gregory August Theodosakis, Martinez, GA (US)

(73) Assignee: Textron Inc., Providence, RI (US)

(21) Appl. No.: 18/887,222

(22) Filed: Sep. 17, 2024

(51) Int. Cl. H01M 50/583; B60L 3/00; B60L 3/04; B60L 50/64; B60L 58/18; G07C 5/08; H01M 10/42; H01M 50/204; H01M 50/296

(52) U.S. Cl. CPC H01M 50/583; B60L 3/0046; B60L 3/0069; B60L 3/04; B60L 50/64; B60L 58/18; G07C 5/0808; G07C 5/085; H01M 10/425; H01M 50/204; H01M 50/296; B60L 2200/22; H01M 2010/4271; H01M 2200/103; H01M 2220/20

(57) ABSTRACT

A battery system includes a plurality of battery packs and a battery management system (BMS). The BMS is operably coupled to the plurality of battery packs. The plurality of battery packs includes a first battery pack and a second battery pack. The first battery pack includes a first plurality of battery cells, a first fuse, and first terminals. The second battery pack includes a second plurality of battery cells, a second fuse, second terminals, and a supplementary fuse. The second terminals are electrically connected in parallel with the first terminals. The BMS is configured to monitor operational parameters of the plurality of battery packs; detect a fault condition in at least one of the plurality of battery packs; and initiate actuation of the supplementary fuse in response to the detected fault condition. The supplementary fuse is configured to blow to isolate the second battery pack from the first battery pack.

### BACKGROUND

Electric vehicles typically include battery management systems. Battery management systems can monitor, control, and maintain the health and efficiency of batteries of such electric vehicles.

### SUMMARY

One embodiment relates to a battery system. The battery system includes a plurality of battery packs and a battery management system (BMS). The BMS is operably coupled to the plurality of battery packs. The plurality of battery packs includes a first battery pack and a second battery pack. The first battery pack includes a first plurality of battery cells, a first fuse, and first terminals. The second battery pack includes a second plurality of battery cells, a second fuse, second terminals, and a supplementary fuse. The second terminals are electrically connected in parallel with the first terminals. The BMS is configured to monitor operational parameters of the plurality of battery packs; detect a fault condition in at least one of the plurality of battery packs; and initiate actuation of the supplementary fuse in response to the detected fault condition. The supplementary fuse is configured to blow to electrically isolate the second battery pack from the first battery pack by initiating an open circuit between the second terminals.

Another embodiment relates to a battery system. The battery system includes a plurality of battery packs and a battery management system (BMS). The BMS is operably coupled to the plurality of battery packs. The plurality of battery packs includes a first battery pack, a second battery pack, and a supplementary fuse. The first battery pack includes a first plurality of battery cells and first terminals. The second battery pack includes a second plurality of battery cells and second terminals. The supplementary fuse is connected in a power connection path between the second terminals of the second battery pack and the first terminals of the first battery pack. The BMS is configured to monitor operational parameters of the plurality of battery packs; detect a fault condition in at least one of the plurality of battery packs; and initiate an actuation of the supplementary fuse in response to the detected fault condition. The supplementary fuse is configured to blow to electrically isolate the second battery pack from the first battery pack by initiating an open circuit between the second terminals and the first terminals.

Still another embodiment relates to a battery system. The battery system includes a plurality of battery packs and a battery management system (BMS). The BMS is operably coupled to the plurality of battery packs. The plurality of battery packs includes a first battery pack, a second battery pack, and a third battery pack. The first battery pack includes a first plurality of battery cells, a first fuse, and first terminals. The second battery pack includes a second plurality of battery cells, a second fuse, second terminals, and a first supplementary fuse. The second terminals are electrically connected in parallel with the first terminals. The third battery pack includes a third plurality of battery cells, a third fuse, third terminals, and a second supplementary fuse. The third terminals are electrically connected in parallel with the first terminals and the second terminals. The BMS is configured monitor operational parameters of the plurality of battery packs; detect a fault condition in at least one of the plurality of battery packs; identify which of the plurality of battery packs is experiencing the fault condition; in response to the second battery pack experiencing the fault condition, initiate actuation of the first supplementary fuse, wherein the first supplementary fuse is configured to blow to electrically isolate the battery system; and in response to the third battery pack experiencing the fault condition, initiate actuation of the second supplementary fuse, wherein the second supplementary fuse is configured to blow to electrically isolate the battery system.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a site monitoring and control system including a plurality of the vehicles of FIG. 1, according to an exemplary embodiment.

FIG. 5 is a schematic block diagram illustrating a battery system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

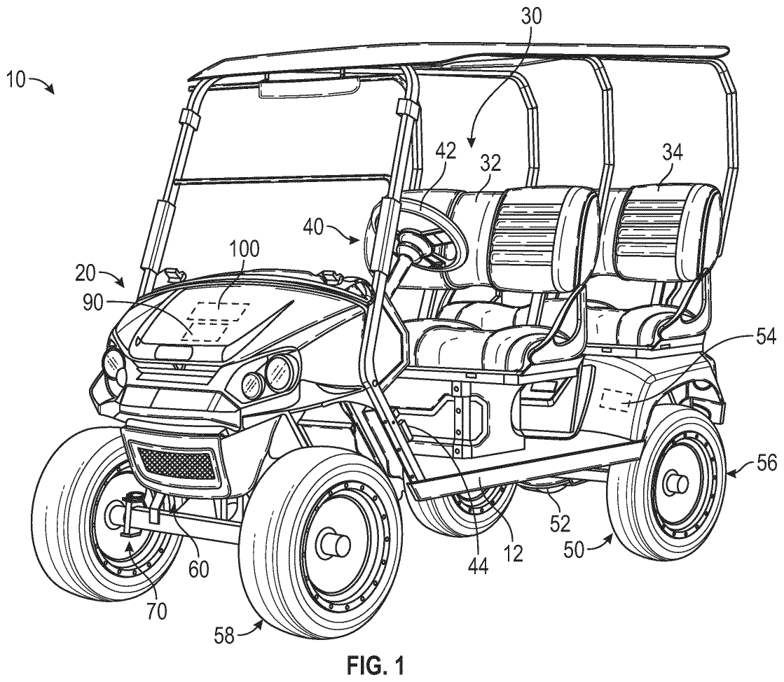

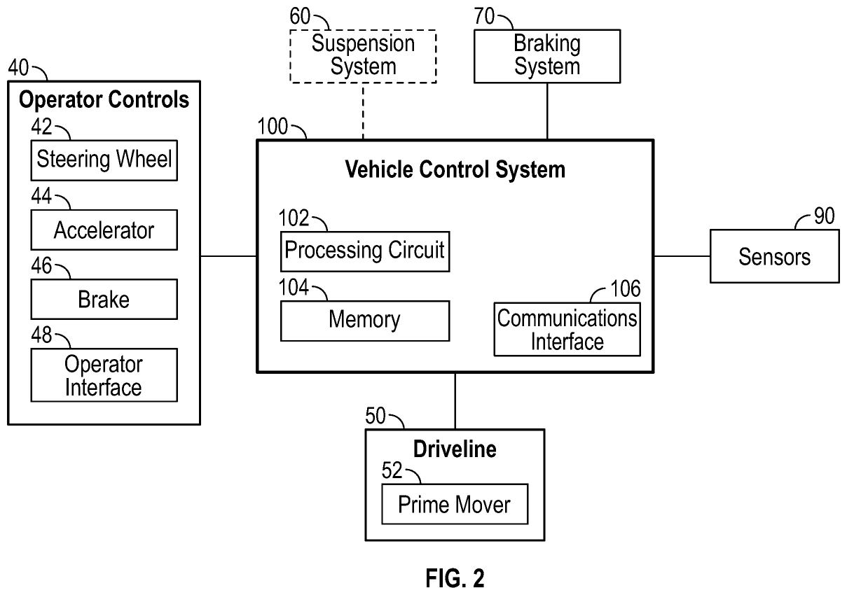

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., motor 53) and the energy storage 54 is a battery system (e.g., battery module 57, add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, Doppler sensors, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

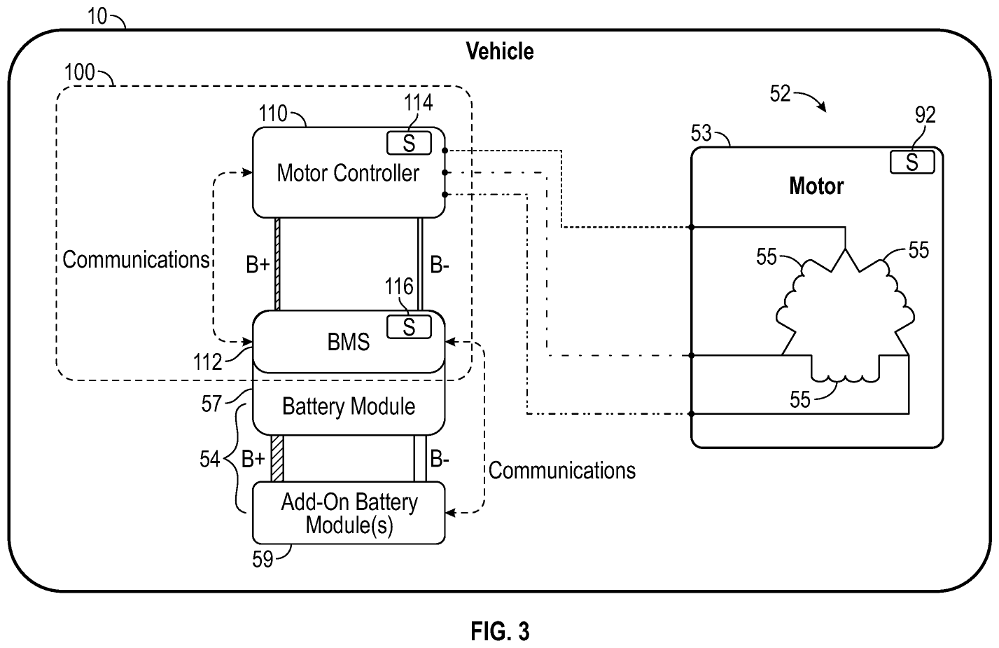

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Site Monitoring and Control System

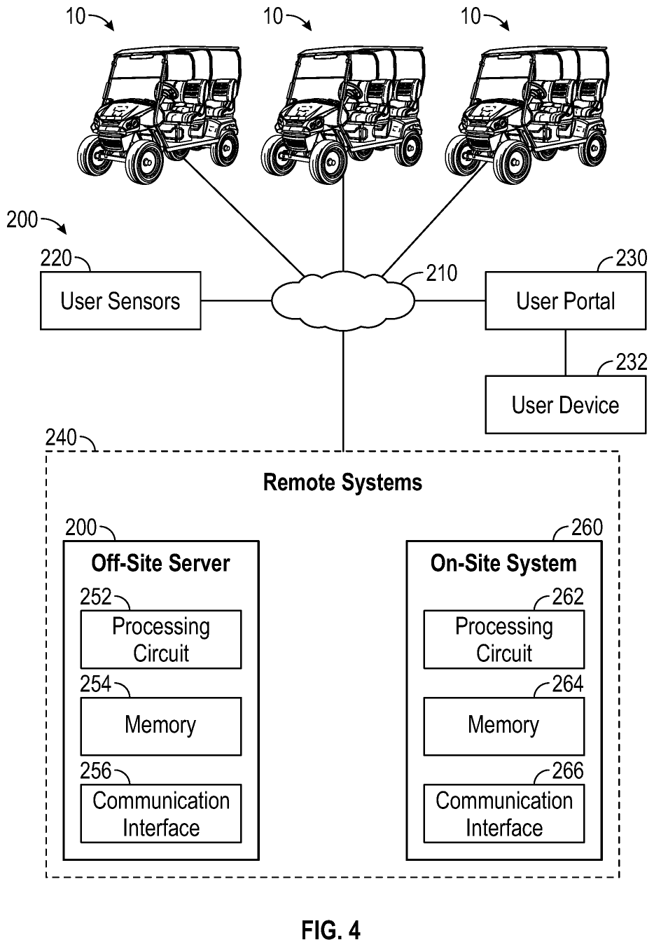

As shown in FIG. 4, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10 and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like.

The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Distributed Battery Circuit Isolation via Pyrotechnic Disconnect

According to an exemplary embodiment, the BMS 112 is configured to monitor operational parameters of battery packs (e.g., the battery module 57 and/or the add-on battery module(s) 59) and constituent battery cells. The battery module 57 and the add-on battery module(s) 59 may be collectively referred to as battery packs 57/59. If the BMS 112 detects fault conditions within battery pack(s) 57/59, such as voltage imbalances, cell failures, or improper charging behavior, the BMS 112 initiates mitigating actions to prevent further damage or failure. An effective way to address such fault conditions is by electrically isolating the battery packs 57/59. To achieve isolation, the systems and methods described herein utilize circuit protection devices (e.g., fuses), which are integrated into the battery packs 57/59. The fuses are intentionally blown by the BMS 112 in response to the detected fault conditions. The systems and methods described herein offer a cost-effective alternative to traditional battery isolation techniques, which often rely on expensive components that are capable of continuously carrying full battery current. Accordingly, the systems and methods, as described in greater detail herein, are configured to monitor operational parameters, detect fault conditions, and, in response, trigger electrical isolation between the battery packs 57/59 by activating a circuit protection device to prevent further damage or failure propagation within the vehicle or battery system.

As described in greater detail herein, the BMS 112 is configured to detect faults or failures in the energy storage 54 (e.g., the battery packs 57/59) and to monitor operational parameters. The BMS 112 is programmed and/or configured to continuously or periodically measure the operational parameters (e.g., temperature, voltage levels, etc.) of each battery cell within the battery packs 57/59. The data collected by the BMS sensor(s) 116 can be transmitted to the BMS 112, where such data can be processed and analyzed. The data collected by the BMS 112 may be used for predictive maintenance. The BMS 112 may be configured to identify which battery pack is experiencing a fault condition (e.g., the battery module 57 or the add-on battery module 59). For example, upon detection of the fault condition, the BMS 112 may be configured to determine the specific battery pack that is affected by analyzing operational data such as voltage, temperature, current deviations, etc. The BMS 112 may be configured to log fault condition data, including the time of occurrence of the fault, the type of fault condition (e.g., overvoltage, undervoltage, overheating, etc.), and which battery pack is affected, among other data. The logged data may be stored in the memory 104.

In accordance with one or more exemplary embodiments, the BMS 112 may include a processing circuit (e.g., on-board processing circuit) located on the vehicle 10, which is responsible for real-time monitoring, control, and management of the vehicle systems, including the battery packs 57/59. The on-board processing circuit allows the vehicle 10 to respond immediately to any detected issues or changes in operating conditions. The BMS 112 may include a second processing circuit located remote from the vehicle 10. The second processing circuit enables external monitoring, diagnostics, and system updates, providing the ability to analyze data and manage the vehicle 10 performance from a distance. The combination of both on-vehicle and remote processing circuits ensures comprehensive control and flexibility in maintaining and optimizing the vehicle 10 operations. Data collected by the BMS 112 is stored in memory 104 for real-time analysis and future reference (e.g., for diagnostic purposes).

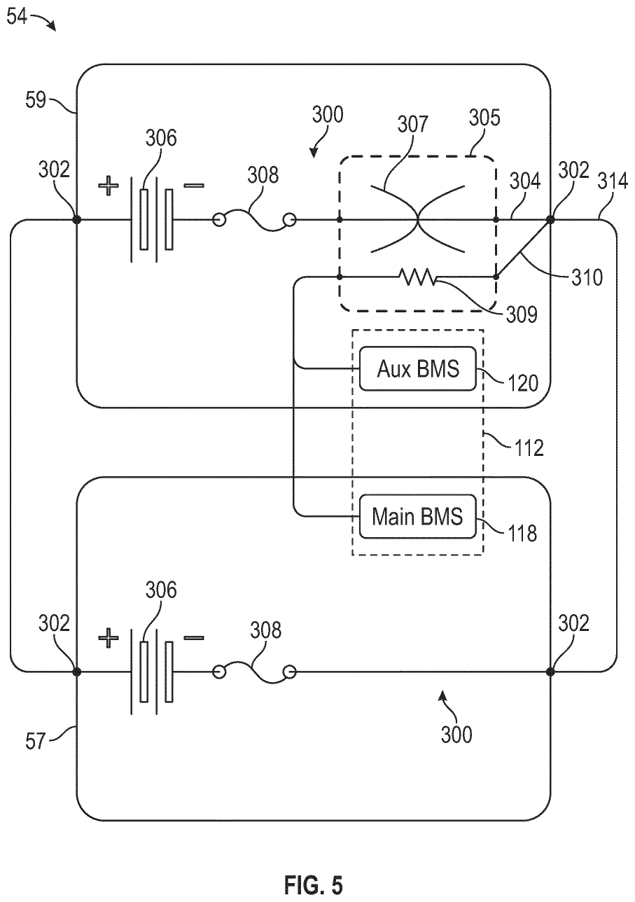

As shown in FIG. 5, the energy storage 54 includes the battery module 57 and one add-on battery module 59. Each of the battery module 57 and the add-on battery module 59 includes internal circuity, shown as battery circuitry 300. The battery circuitry 300 includes a pair of terminals (e.g., positive and negative terminals), shown as battery terminals 302; a first electrical pathway or branch, shown as battery path 304, extending between the terminals 302; one or more battery cells, shown as battery cells 306, disposed along the battery path 304 between the terminals 302; and a first fuse, shown as fuse 308, disposed along the battery path 304 between the terminals 302, which is part of a circuit protection mechanism. The terminals 302 of the battery module 57 and the add-on battery module 59 are connected in parallel via connections (e.g., wiring, bus bars, etc.), shown as module connectors 314, allowing the battery packs 57/59 to work together and distribute the current load. In some embodiments, a plurality of the add-on battery modules 59 are connected in parallel with the battery module 57.

As shown in FIG. 5, the battery circuitry 300 of the add-on battery module 59 includes a second electrical pathway or branch, shown as circuit path 310, extending between one of the terminals 302 and the BMS 112. The battery circuitry 300 of the add-on battery module 59 includes a second fuse, shown as supplementary fuse assembly 305, disposed along the circuit path 310, which is part of the circuit protection mechanism controlled by the BMS 112. According to the exemplary embodiment shown in FIG. 5, the battery module 57 does not include the circuit path 310 or the supplementary fuse assembly 305. The absence of the circuit path 310 in the battery module 57 simplifies the battery circuitry 300 and reduces the number of components required to perform the circuit protection described herein. In some embodiments, the battery module 57 includes the circuit path 310 and the supplementary fuse assembly 305.

In some implementations, the supplementary fuse assembly 305 is connected in a power connection path between the terminals of the battery module 57 and the terminals of the add-on battery module 59 (e.g., along module connectors 314). The connection in the power connection path ensures that the supplementary fuse assembly 305 may effectively monitor and control the electrical interaction between the battery packs 57/59, and may interrupt the flow of current between the battery packs 57/59 when a fault condition is detected.

As shown in FIG. 5, the BMS 112 includes a first BMS, shown as main BMS 118, disposed within or part of the battery module 57 and a second BMS, shown as auxiliary BMS 120, disposed within or part of the add-on battery module 59. According to an exemplary embodiment, the main BMS 118 is configured to control and monitor the battery module 57 and the auxiliary BMS 120 is configured to control and monitor the add-on battery module 59. The main BMS 118 and the auxiliary BMS 120 are configured to detect faults; monitor voltage, current, and temperature; and manage the response of the battery packs 57/59 to any fault conditions or detected issues.

As shown in FIG. 5, the main BMS 118 and the auxiliary BMS 120 are connected to the supplementary fuse assembly 305. The auxiliary BMS 120 may work in conjunction with the main BMS 118 to provide an additional layer of localized control. According to an exemplary embodiment, the main BMS 118, upon detecting a fault condition in the battery module 57, is configured to generate and transmit a fault or control signal to the auxiliary BMS 120 and/or the supplementary fuse assembly 305. Similarly, if auxiliary BMS 120 detects a fault in the add-on battery module 59, the auxiliary BMS 120 is configured to generate and transmit a fault or control signal to the main BMS 118 and/or the supplementary fuse assembly 305. The communication between the main BMS 118 and the auxiliary BMS 120 may facilitate coordinated fault response between the battery packs 57/59.

In some embodiments, the supplementary fuse assembly 305 is configured to be actuated in response to signals generated by the BMS 112, the main BMS 118, and/or the auxiliary BMS 120. The supplementary fuse assembly 305 is configured to provide an open circuit between the battery packs 57/59 when a fault condition is detected, ensuring electrical isolation between the battery packs 57/59. Upon detecting the fault condition, such as voltage imbalance, overcurrent, or abnormal temperature, the BMS 112, the main BMS 118, and/or the auxiliary BMS 120 is configured to send a control signal, actuation signal, and/or fault signal (e.g., electrical pulse) to the supplementary fuse assembly 305. The supplementary fuse assembly 305 is configured to respond to the electrical pulse triggered/transmitted by the BMS 112 control signal.

As shown in FIG. 5, the supplementary fuse assembly 305 includes a supplementary fuse 307 and a resistor 309. In some implementations, upon receiving the electrical pulse, a charge (e.g., pyrotechnic charge) ignites inside the supplementary fuse 307, generating a controlled explosion (e.g., pyrotechnic reaction) or rapid expansion of gas. The controlled explosion or rapid expansion of gas creates a mechanical force that causes a physical disconnection within the supplementary fuse assembly 305, breaking a conductive path between the battery packs 57/59. In some implementations, the mechanical force acts to break or sever a conductive element (e.g., a metal strip or wire) within the supplementary fuse assembly 305. In some implementations, the controlled explosion results in vaporization or melting of the conductive element and/or conductive path due to heat generated by the controlled explosion.

The supplementary fuse 307 may be any type of fuse capable of initiating and/or creating a rapid and reliable disconnection between the battery packs 57/59 in response to an actuation signal. In one example, the supplementary fuse 307 is a pyrotechnic fuse. The pyrotechnic fuse utilizes a pyrotechnic charge to trigger a mechanical or thermal event that severs the conductive path. The pyrotechnic charge may include chemical compounds such as lead azide, potassium perchlorate, or zirconium potassium perchlorate, which, when ignited by an electric pulse, generate a controlled explosion or rapid expansion of gas. The pyrotechnic charge generates a reaction (e.g., pyrotechnic reaction) that creates a mechanical force that can either physically break a conductive wire or vaporize a metal element, thereby opening the battery circuitry 300.

In some embodiments, the resistor 309 is configured to regulate, control, and/or limit the current flowing through the circuit path 310 and the battery path 304 when the BMS 112, the main BMS 118, and/or the auxiliary BMS 120 sends the actuation signal (e.g., electrical pulse) to the supplementary fuse 305. The resistor 309 ensures that a necessary amount of energy is delivered to the pyrotechnic charge within the supplementary fuse 307, and thereby prevents unintended damage to sensitive components and ensures that the pyrotechnic charge is ignited when required. In certain embodiments, the resistor 309 provides a mechanism to protect the battery circuitry 300 and the BMS 112 from electrical overload. The resistor 309 ensures that sufficient energy is delivered to ignite the pyrotechnic charge within the supplementary fuse 305, thereby allowing the fuse to blow while preventing unintended damage to other components in the battery circuitry 300.

The open circuit initiated by the supplementary fuse assembly 305 isolates the add-on battery module 59 from the battery module 57, preventing further electrical interaction therebetween. Once activated, the supplementary fuse assembly 305 permanently disconnects the affected battery pack(s) from the battery system, providing a fail-safe solution for fault conditions. The disclosed systems and methods avoid the need for continuous power consumption to maintain a disconnected state, unlike traditional mechanical relays or contactors.

According to an exemplary embodiment, the BMS 112 is configured to initiate the open circuit only after the fault condition has persisted for a predetermined time duration and/or the fault conditions exceeds an elevated risk threshold. The time duration ensures that transient fault conditions or minor fluctuations do not trigger unnecessary isolation, allowing the BMS 112 to distinguish between temporary anomalies and more serious, sustained faults. Also, the elevated risk threshold facilitates taking immediate action if the fault is serious enough, whereas if the fault is not currently a serious risk, other mitigating actions can be attempted prior to activating the supplementary fuse assembly 305. Once the fault condition remains beyond the predetermined time duration or exceeds the elevated risk threshold, the BMS 112 activates the open circuit mechanisms to isolate the affected battery pack and prevent further damage.

In other implementations, the supplementary fuse assembly 305 can be a more traditional fuse type, such as a thermal fuse, designed to melt or break under excessive current. However, pyrotechnic fuses offer advantages in speed and precision. The electric pulse used to trigger the fuse can be a low-energy pulse, typically in the millisecond range, provided by the BMS 112, the main BMS 118, or the auxiliary BMS 120.

In embodiments where the energy storage 54 includes a plurality of add-on battery modules 59, the BMS 112 may be configured to detect which add-on module 59 is experiencing the fault and blow only the supplementary fuse 307 of the add-on module 59 that is the cause of the fault. Accordingly, the battery module 57 and the other add-on modules 59 that are working properly can be maintained in an operable state.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and descriptions may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A battery system comprising:
a plurality of battery packs including:
a first battery pack including a first plurality of battery cells, a first fuse, and first terminals;
a second battery pack including a second plurality of battery cells, a second fuse, second terminals, and a supplementary fuse, the second terminals electrically connected in parallel with the first terminals,
a battery management system (BMS) operably coupled to the plurality of battery packs, the BMS configured to:
monitor operational parameters of the plurality of battery packs;
detect a fault condition in at least one of the plurality of battery packs; and
initiate actuation of the supplementary fuse in response to the detected fault condition, wherein the supplementary fuse is configured to blow to electrically isolate the second battery pack from the first battery pack by initiating an open circuit between the second terminals.

2. The battery system of claim 1, wherein the supplementary fuse is a pyrotechnic fuse.

3. The battery system of claim 1, wherein the supplementary fuse requires a short-duration electrical pulse to blow.

4. The battery system of claim 1, wherein the BMS is configured to identify which of the plurality of battery packs is experiencing the fault condition prior to initiating the open circuit.

5. The battery system of claim 4, wherein the BMS is configured to log fault condition data including a time of occurrence the fault condition, a type of the fault condition, and which of the plurality of battery packs is affected.

6. The battery system of claim 1, wherein the BMS is configured to initiate the open circuit in response to the fault condition being present for a predetermined time duration.

7. The battery system of claim 1, wherein the open circuit is initiated by a fault signal generated by the BMS.

8. The battery system of claim 7, wherein the BMS include a first BMS associated with the first battery pack and a second BMS associated with the second battery pack.

9. The battery system of claim 8, wherein the first BMS is configured to generate and transmit the fault signal to the second BMS in response to the first BMS detecting the fault condition with the first battery pack
10. The battery system of claim 8, wherein the second BMS is configured to generate the fault signal in response to the second BMS detecting the fault condition with the second battery pack.

11. The battery system of claim 1, wherein the fault condition includes a voltage imbalance among the first plurality of battery cells in the first battery pack or the second plurality of battery cells in the second battery pack.

12. The battery system of claim 1, wherein the fault condition includes a current flow detected by the BMS that indicates an unintended electrical connection.

13. The battery system of claim 1, wherein the supplementary fuse is triggered by an external control function coupled by a communication link to the BMS.

14. The battery system of claim 1, wherein the supplementary fuse includes a resistor configured to control current flow.

15. The battery system of claim 1, wherein the supplementary fuse is a first supplementary fuse, wherein the plurality of battery packs include a third battery pack including a third plurality of battery cells, a third fuse, third terminals, and a second supplementary fuse, wherein the third terminals electrically connected in parallel with the first terminals and the second terminals, and wherein the BMS is configured to:
identify which of the plurality of battery packs is experiencing the fault condition; in response to the second battery pack experiencing the fault condition, initiate actuation of the first supplementary fuse; and
in response to the third battery pack experiencing the fault condition, initiate actuation of the second supplementary fuse.

16. A battery system comprising:
a plurality of battery packs including:
a first battery pack including a first plurality of battery cells, and first terminals;
a second battery pack including a second plurality of battery cells, second terminals, the second terminals electrically connected in parallel with the first terminals,
a supplementary fuse connected in a power connection path between the second terminals of the second battery pack and the first terminals of the first battery pack,
a battery management system (BMS) operably coupled to the plurality of battery packs, the BMS configured to:
monitor operational parameters of the plurality of battery packs;
detect a fault condition in at least one of the plurality of battery packs; and
initiate an actuation of the supplementary fuse in response to the detected fault condition, wherein the supplementary fuse is configured to blow to electrically isolate the second battery pack from the first battery pack by initiating an open circuit between the second terminals and the first terminals.

17. The battery system of claim 16, wherein the supplementary fuse is a pyrotechnic fuse.

18. The battery system of claim 16, wherein the supplementary fuse requires a short-duration electrical pulse to blow.

19. The battery system of claim 16, wherein the open circuit is initiated by a fault signal generated by the BMS.

20. A battery system comprising:
a plurality of battery packs including:
a first battery pack including a first plurality of battery cells, a first fuse, and first terminals;
a second battery pack including a second plurality of battery cells, a second fuse, second terminals, and a first supplementary fuse, the second terminals electrically connected in parallel with the first terminals,
a third battery pack including a third plurality of battery cells, a third fuse, third terminals, and a second supplementary fuse, the third terminals electrically connected in parallel with the first terminals and the second terminals,
a battery management system (BMS) operably coupled to the plurality of battery packs, the BMS configured to:
monitor operational parameters of the plurality of battery packs;
detect a fault condition in at least one of the plurality of battery packs;
identify which of the plurality of battery packs is experiencing the fault condition;
in response to the second battery pack experiencing the fault condition, initiate actuation of the first supplementary fuse, wherein the first supplementary fuse is configured to blow to electrically isolate the battery system; and
in response to the third battery pack experiencing the fault condition, initiate actuation of the second supplementary fuse, wherein the second supplementary fuse is configured to blow to electrically isolate the battery system.
